(19) United States
(12) Patent Application Publication
(10) Pub. No.: US 2026/0213417 A1
(43) Pub. Date: Jul. 23, 2026

(54) SYMMETRICALLY FED WAVEGUIDE ANTENNA ARRAY ELEMENT AND WAVEGUIDE ANTENNA ARRAY

(71) Applicant: NANTONG PANYOO ZH TECHNOLOGY CO., LTD., Nantong (CN)

(72) Inventors: Haoyu WAN, Nantong (CN); Yizhou WU, Nantong (CN); Zhongyue WANG, Nantong (CN); Linlin SONG, Nantong (CN)

(73) Assignee: NANTONG PANYOO ZH TECHNOLOGY CO., LTD., Nantong (CN)

(21) Appl. No.: 19/458,970

(22) Filed: Jan. 26, 2026

Related U.S. Application Data
(63) Continuation of application No. PCT/CN2025/093294, filed on May 8, 2025.

(30) Foreign Application Priority Data
Jan. 23, 2025 (CN) 202510105323.5

(51) Int. Cl. H01Q 13/02; H01Q 21/00

(52) U.S. Cl. CPC H01Q 13/02; H01Q 21/0006

(57) ABSTRACT

A symmetrically fed waveguide antenna array element includes a 180° E-plane power divider, a first E-plane feed line, a second E-plane feed line, a first E-plane-to-H-plane waveguide converter, a second E-plane-to-H-plane waveguide converter, an H-plane waveguide, and a radiation slot array. With the differential symmetric feeding scheme and the equally-divided symmetric feeding scheme, the present disclosure has advantages of a broad operation bandwidth, a symmetric radiation pattern, and flexible adjustment for the physical aperture size of the antenna, and can address many key pain points. By optimizing the impedance matching, the present disclosure makes symmetric feeding networks more compact to achieve wide application scenarios. The symmetrically fed waveguide antenna array element can be implemented either on two metallized injection-molded parts via welding, or on a metallized injection-molded part and a thin copper sheet, thereby significantly reducing the thickness of the antenna.

### CROSS-REFERENCE TO THE RELATED APPLICATIONS

This application is a Continuation Application of International Application No. PCT/CN2025/093294, filed May 08, 2025, which is based upon and claims priority to Chinese Patent Application No. 202510105323.5, filed on January 23, 2025, the entire contents of which are incorporated herein by reference.

### TECHNICAL FIELD

The present disclosure relates to an antenna array element and a waveguide antenna array, and in particular to a symmetrically fed waveguide antenna array element and a waveguide antenna array, which belong to the technical field of antennas.

### BACKGROUND

Waveguide antennas utilize waveguide structures to transmit and radiate electromagnetic waves. Waveguides, as structures for channelizing electromagnetic waves, are typically filled with air or vacuum, but they may also be filled with other dielectric materials. Waveguide antennas typically exhibit high directivity and gain, and have therefore been widely used in the fields such as radar, satellite communications, microwave measurements, radio broadcasting, and television.

Chinese Patent Application No. CN 108336507 A discloses a symmetrically fed traveling-wave C-shaped waveguide antenna array applied to Ku-band satellite communication, including a metal C-shaped waveguide power divider. A metal C-shaped waveguide antenna radiating element is disposed between two ports of the metal C-shaped waveguide power divider. A feeding metal diaphragm and a metal disc are disposed on an inner wall of the metal C-shaped waveguide power divider. The symmetrically fed traveling-wave C-shaped waveguide antenna array further includes a coaxial adapter. The coaxial adapter is inserted into the metal C-shaped waveguide power divider through a metal probe. The antenna in this scheme has a simple structure with a small size, can be manufactured easily, achieves broadband impedance matching, and balances miniaturization with broadband performance. Furthermore, when a voltage standing wave ratio (VSWR) is less than 2, this scheme exhibits a relative bandwidth of 8.2%, a high main lobe gain, and a low side lobe level (SLL), enhancing radiation efficiency.

This scheme cannot achieve miniaturization due to excessive height, and it requires a large number of layers. Since the feeding metal diaphragm and the metal disc are mounted on the inner wall of the metal C-shaped waveguide power divider, and the coaxial adapter is inserted into the metal C-shaped waveguide power divider via the metal probe, this scheme suffers from a high cost and requires high manufacturing precision in the 77-GHz band.

Chinese Patent Application No. CN 113904097 A discloses a waveguide antenna, a radar, and a vehicle. The waveguide antenna includes an antenna body, a radiation slot array, and beam-expanding radiation slots. The antenna body includes a radiation array plane. The radiation slot array is disposed on the radiation array plane. The radiation slot array and the antenna body constitute the antenna capable of generating a radiation signal. The beam-expanding radiation slots are formed in the radiation array plane, and respectively located on two sides of the radiation slot array. The beam-expanding radiation slots are configured to cut a current on the radiation array plane to generate a radiation signal. The radiation signal from the beam-expanding radiation slots and the radiation signal from the radiation slot array are superimposed to expand a beam width of the waveguide antenna. The waveguide antenna provided by this scheme solves the problem of the narrow beam in existing waveguide antennas.

In this scheme, the antenna exhibits relatively high SLLs in some directions. For cost savings, a side feeding scheme is used. When a frequency of the antenna deviates from a center frequency, the H-plane beam pointing angle of the antenna deviates from 0°, thereby narrowing the operating bandwidth of the antenna. If a center feeding scheme is used, it results in higher overall cost, increased mounting cost, and a reduced yield rate.

Chinese Patent Application No. CN 216055193 U discloses a millimeter-wave flat-panel waveguide array antenna. The millimeter-wave flat-panel waveguide array antenna includes a radiation array panel, a feeding panel, and an output waveguide panel. The radiation array panel, the feeding panel, and the output waveguide panel use electroplatable plastic with low warpage and low deformation as the base material, and are formed by high-speed and high-precision injection molding. Then, plasma treatment is performed on the surfaces of the molded parts. Next, a metal layer is formed by vacuum-sputtering, specifically, by depositing a silver layer onto a copper substrate. Finally, solder paste is printed onto discontinuous or offset weld regions, followed by reflow soldering, thereby achieving continuous and closed welding of the waveguide cavity. This scheme features a simple process, fast welding, high production efficiency, and significantly reduced cost.

However, the center feeding scheme adopted in this scheme results in an increased number of antenna layers, more mounting operations, and a lower antenna yield rate.

In summary, the prior art exhibits the following defects:

1. The side feeding scheme results in a narrow operating bandwidth and an asymmetric radiation pattern for the waveguide antenna.

2. Conventional offset slots lead to high SLLs in the radiation pattern of the antenna at certain angles.

3. The conventional center feeding scheme employs a three-layer waveguide antenna structure, leading to high cost.

4. In addition to main signals, conventional waveguide antennas include other components, which cause significant ripples in multi-channel antennas at large angles. Typically, absorbing materials are employed to suppress these components.

5. Conventional two-layer cavity schemes commonly require an even number of radiating apertures.

### SUMMARY

A technical problem to be solved by the present disclosure is to provide a symmetrically fed waveguide antenna array element and a waveguide antenna array, to achieve a broader operation bandwidth, a symmetric radiation pattern, a low SLL, and a low cost.

To solve the above technical problems, the present disclosure adopts the following technical solutions:

A symmetrically fed waveguide antenna array element includes a 180° E-plane power divider, a first E-plane feed line, a second E-plane feed line, a first E-plane-to-H-plane waveguide converter, a second E-plane-to-H-plane waveguide converter, an H-plane waveguide, and a radiation slot array, where a first output port of the 180° E-plane power divider is connected to one end of the first E-plane feed line; another end of the first E-plane feed line is connected to an input end of the first E-plane-to-H-plane waveguide converter; an output end of the first E-plane-to-H-plane waveguide converter is connected to one end of the H-plane waveguide; a second output port of the 180° E-plane power divider is connected to one end of the second E-plane feed line; another end of the second E-plane feed line is connected to an input end of the second E-plane-to-H-plane waveguide converter; an output end of the second E-plane-to-H-plane waveguide converter is connected to another end of the H-plane waveguide; the radiation slot array is disposed on a top side of the H-plane waveguide; the first E-plane feed line and the second E-plane feed line have a same length; and the radiation slot array includes an even number of radiating apertures.

Further, the first E-plane-to-H-plane waveguide converter and the second E-plane-to-H-plane waveguide converter each are provided with an impedance matching step.

Further, there are four radiating apertures that are a first radiating aperture, a second radiating aperture, a third radiating aperture, and a fourth radiating aperture in sequence; the first radiating aperture, the second radiating aperture, the third radiating aperture, and the fourth radiating aperture have dimensions of 0.9 mm × 2.2 mm × 1.7 mm; and a center-to-center spacing between adjacent ones of the first radiating aperture, the second radiating aperture, the third radiating aperture, and the fourth radiating aperture is 3.3 mm.

Further, the H-plane waveguide includes a first rectangular portion, a first trapezoidal protrusive portion, a second trapezoidal protrusive portion, and a second rectangular portion; one end of the first rectangular portion is connected to one end of the first trapezoidal protrusive portion; another end of the first trapezoidal protrusive portion is connected to one end of the second trapezoidal protrusive portion; another end of the second trapezoidal protrusive portion is connected to one end of the second rectangular portion; the first trapezoidal protrusive portion protrudes toward one side of the H-plane waveguide; the second trapezoidal protrusive portion protrudes toward another side of the H-plane waveguide; the first trapezoidal protrusive portion and the second trapezoidal protrusive portion are point-symmetric about a central point of the H-plane waveguide; the first rectangular portion and the second rectangular portion are offset toward two sides of the H-plane waveguide in a length direction; and the first rectangular portion and the second rectangular portion are also point-symmetric about the central point of the H-plane waveguide.

A symmetrically fed waveguide antenna array element includes a 180° E-plane power divider, a first E-plane feed line, a second E-plane feed line, a first E-plane-to-H-plane waveguide converter, a second E-plane-to-H-plane waveguide converter, an H-plane waveguide, and a radiation slot array, where a first output port of the 180° E-plane power divider is connected to one end of the first E-plane feed line; another end of the first E-plane feed line is connected to an input end of the first E-plane-to-H-plane waveguide converter; an output end of the first E-plane-to-H-plane waveguide converter is connected to one end of the H-plane waveguide; a second output port of the 180° E-plane power divider is connected to one end of the second E-plane feed line; another end of the second E-plane feed line is connected to an input end of the second E-plane-to-H-plane waveguide converter; an output end of the second E-plane-to-H-plane waveguide converter is connected to another end of the H-plane waveguide; the radiation slot array is disposed on a top side of the H-plane waveguide; the first E-plane feed line and the second E-plane feed line have a length difference of X, such that a phase difference between signals respectively passing through the two feed lines is 180°; and the radiation slot array includes an odd number of radiating apertures.

Further, there are three radiating apertures that are a fifth radiating aperture, a sixth radiating aperture, and a seventh radiating aperture in sequence.

Further, the H-plane waveguide includes a third rectangular portion, a third trapezoidal protrusive portion, and a fourth rectangular portion; one end of the third rectangular portion is connected to one end of the third trapezoidal protrusive portion; another end of the third trapezoidal protrusive portion is connected to one end of the fourth rectangular portion; the third trapezoidal protrusive portion protrudes toward one side of the H-plane waveguide; and the third rectangular portion and the fourth rectangular portion are symmetrically disposed on two ends of the third trapezoidal protrusive portion.

Further, the fifth radiating aperture, the sixth radiating aperture, and the seventh radiating aperture are rectangular-slot radiating apertures.

Further, the fifth radiating aperture, the sixth radiating aperture, and the seventh radiating aperture are rectangular-horn radiating apertures.

A waveguide antenna array includes an even number of symmetrically fed waveguide antenna array elements, where the even number of symmetrically fed waveguide antenna array elements are equally divided into two groups; and one group of symmetrically fed waveguide antenna array elements serves as a signal transmitting element group, while the other group of symmetrically fed waveguide antenna array elements serves as a signal receiving element group.

Compared with the prior art, the present disclosure has the following advantages and effects:

1. The present disclosure makes use of the symmetric feeding scheme to expand the operation bandwidth of the antenna. High symmetry of the feeding can ensure the symmetry of the radiation pattern.

2. With the differential symmetric feeding scheme, the present disclosure transmits the signal in positive and negative paths, and this process is called differential transmission. The two paths of signals can mutually counteract partial interference during transmission due to their different polarities, thereby achieving more stable signal transmission, and ensuring that SLLs at all angles are not aggravated by such interference.

3. Since the symmetric feeding networks are compact, and are located at a same side of the waveguide antenna, the present disclosure only requires two layers of waveguides, reducing the cost, and omitting the mounting of one layer.

4. The present disclosure is applicable to the even number of radiating apertures or the odd number of radiating apertures. It can be implemented either on a metallized injection-molded part and a thin copper sheet, or on two metallized injection-molded parts.

### BRIEF DESCRIPTION OF THE DRAWINGS

FIG. 1 is a schematic view in Embodiment 1 of a symmetrically fed waveguide antenna array element according to the present disclosure;

FIG. 2 is a schematic plan view in Embodiment 1 of a symmetrically fed waveguide antenna array element according to the present disclosure;

FIG. 3 is a schematic simulation diagram of an operation bandwidth in Embodiment 1 of a symmetrically fed waveguide antenna array element according to the present disclosure;

FIGS. 4A-4B show a schematic simulation diagram of a radiation pattern in Embodiment 1 of a symmetrically fed waveguide antenna array element according to the present disclosure;

FIG. 5 is a schematic view in Embodiment 2 of a symmetrically fed waveguide antenna array element according to the present disclosure;

FIG. 6 is a schematic simulation diagram of an operation bandwidth in Embodiment 2 of a symmetrically fed waveguide antenna array element according to the present disclosure;

FIGS. 7A-7B show a schematic simulation diagram of a radiation pattern in Embodiment 2 of a symmetrically fed waveguide antenna array element according to the present disclosure;

FIG. 8 is a schematic view in Embodiment 3 of a symmetrically fed waveguide antenna array element according to the present disclosure;

FIG. 9 is a schematic simulation diagram of an operation bandwidth in Embodiment 3 of a symmetrically fed waveguide antenna array element according to the present disclosure;

FIGS. 10A-10B show a schematic simulation diagram of a radiation pattern in Embodiment 3 of a symmetrically fed waveguide antenna array element according to the present disclosure; and

FIG. 11 is a schematic view of a waveguide antenna array according to the present disclosure.

### DETAILED DESCRIPTION OF THE EMBODIMENTS

In order to elaborate the technical solutions adopted by the present disclosure to achieve predetermined technical objectives, the following clearly and completely describes the technical solutions in the embodiments of the present disclosure with reference to the accompanying drawings in the embodiments of the present disclosure. Apparently, the described embodiments are merely a part rather than all of the embodiments of the present disclosure. Furthermore, replacements can be made to the technical means or technical features in the embodiments of the present disclosure, without involving creative labor. The present disclosure will be described in detail below with reference to the accompanying drawings and embodiments.

### Embodiment 1

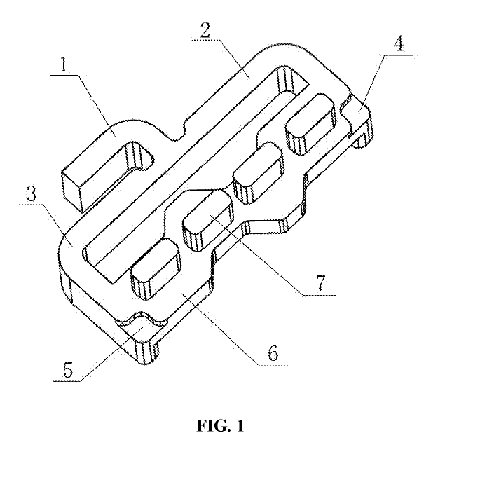

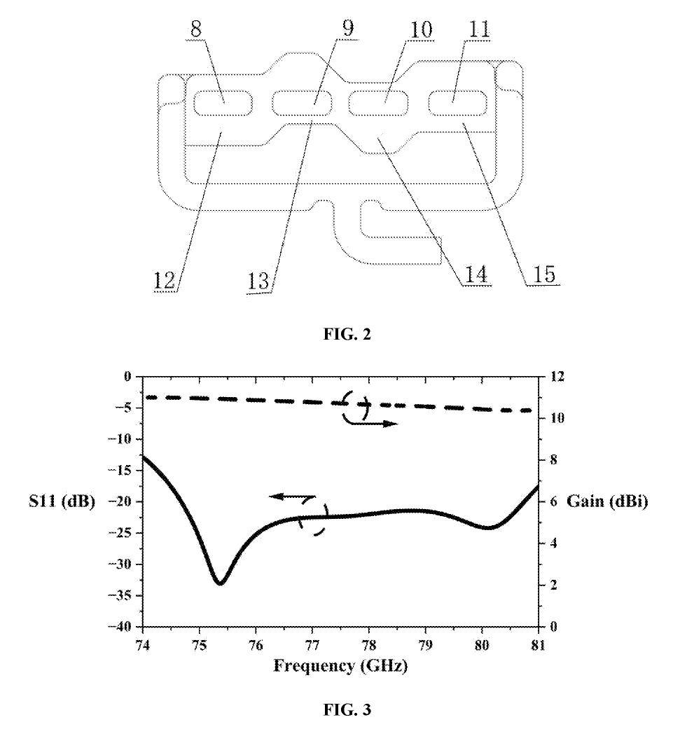

As shown in FIG. 1 and FIG. 2, the present disclosure provides a symmetrically fed waveguide antenna array element, including 180° E-plane power divider 1, first E-plane feed line 2, second E-plane feed line 3, first E-plane-to-H-plane waveguide converter 4, second E-plane-to-H-plane waveguide converter 5, H-plane waveguide 6, and radiation slot array 7. A first output port of the 180° E-plane power divider 1 is connected to one end of the first E-plane feed line 2. Another end of the first E-plane feed line 2 is connected to an input end of the first E-plane-to-H-plane waveguide converter 4. An output end of the first E-plane-to-H-plane waveguide converter 4 is connected to one end of the H-plane waveguide 6. A second output port of the 180° E-plane power divider 1 is connected to one end of the second E-plane feed line 3. Another end of the second E-plane feed line 3 is connected to an input end of the second E-plane-to-H-plane waveguide converter 5. An output end of the second E-plane-to-H-plane waveguide converter 5 is connected to another end of the H-plane waveguide 6. The radiation slot array 7 is disposed on a top side of the H-plane waveguide 6. The first E-plane feed line 2 and the second E-plane feed line 3 have a same length. The radiation slot array 7 includes an even number of radiating apertures.

In the present disclosure, a signal is fed from an input end of the 180° E-plane power divider 1. Through the 180° E-plane power divider 1, energy is equally divided into two paths of signals with a phase difference of 180°. The two paths of signals respectively pass through the first E-plane feed line 2 and the second E-plane feed line 3 having the same length, and then respectively are converted by the first E-plane-to-H-plane waveguide converter 4 and the second E-plane-to-H-plane waveguide converter 5, thereby feeding into the H-plane waveguide 6.

The first E-plane-to-H-plane waveguide converter 4 and the second E-plane-to-H-plane waveguide converter 5 each are provided with an impedance matching step. In conventional symmetric feeding schemes, the longitudinal size of the antenna (parallel to the central axis of the radiating element) is significantly increased by about one wavelength. By miniaturizing the E-plane-to-H-plane waveguide converter, the present disclosure achieves the compact symmetric feeding scheme. The E-plane waveguide is directly converted to the H-plane waveguide first, and at this time, only the width of the E-plane waveguide is increased by about 1 mm, and two sides of the antenna are increased by about 2 mm, i.e., about half the wavelength. Nevertheless, the antenna fails to achieve impedance matching. In the present disclosure, the E-plane-to-H-plane waveguide converter is provided with the impedance matching step to optimize performance of the E-plane-to-H-plane waveguide converter, thereby realizing the lossless transmission of the energy. Meanwhile, the horizontal plane of the antenna can also be miniaturized by reducing the structure of the E-plane power divider. A minimum spacing between channels on two sides of the E-plane power divider can be 1 mm, and the structure of the impedance matching step is optimized, thereby realizing the lossless transmission of the energy.

There are four radiating apertures that are first radiating aperture 8, second radiating aperture 9, third radiating aperture 10, and fourth radiating aperture 11 in sequence. The first radiating aperture 8, the second radiating aperture 9, the third radiating aperture 10, and the fourth radiating aperture 11 have dimensions of 0.9 mm × 2.2 mm × 1.7 mm. A center-to-center spacing between adjacent ones of the first radiating aperture 8, the second radiating aperture 9, the third radiating aperture 10, and the fourth radiating aperture 11 is 3.3 mm.

The H-plane waveguide 6 includes first rectangular portion 12, first trapezoidal protrusive portion 13, second trapezoidal protrusive portion 14, and second rectangular portion 15. One end of the first rectangular portion 12 is connected to one end of the first trapezoidal protrusive portion 13. Another end of the first trapezoidal protrusive portion 13 is connected to one end of the second trapezoidal protrusive portion 14. Another end of the second trapezoidal protrusive portion 14 is connected to one end of the second rectangular portion 15. The first trapezoidal protrusive portion 13 protrudes toward one side of the H-plane waveguide 6. The second trapezoidal protrusive portion 14 protrudes toward another side of the H-plane waveguide 6. The first trapezoidal protrusive portion 13 and the second trapezoidal protrusive portion 14 are point-symmetric about a central point of the H-plane waveguide 6. The first rectangular portion 12 and the second rectangular portion 15 are offset toward two sides of the H-plane waveguide 6 in a length direction. The first rectangular portion 12 and the second rectangular portion 15 are also point-symmetric about the central point of the H-plane waveguide 6.

To reduce SLLs of the antenna, it is required that the second radiating aperture 9 and the third radiating aperture 10 have higher energy, while the first radiating aperture 8 and the fourth radiating aperture 11 have lower energy. Therefore, the H-plane waveguide 6 is trapezoidally bent, and a distance between each radiating aperture and a central axis of the waveguide is controlled by a bending angle. Since the second radiating aperture 9 and the third radiating aperture 10 require the high energy, their bending angles (i.e., the inclination angle between the leg and the base of each trapezoid) range from 30° to 60°. Since the first radiating aperture 8 and the fourth radiating aperture 11 require the low energy, it is only necessary to design a waveguide cavity away from the first radiating aperture 8 and the fourth radiating aperture 11.

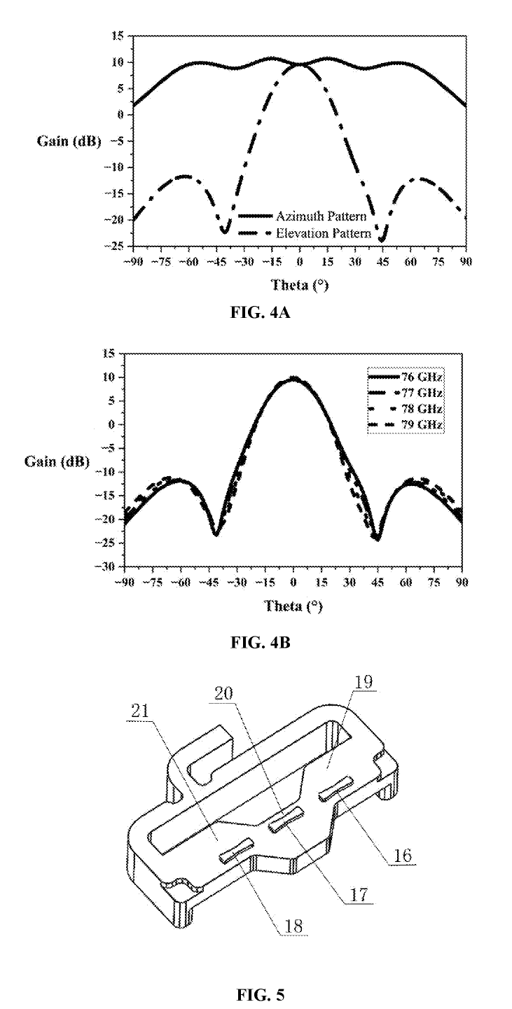

FIG. 3 is a schematic simulation diagram of an operation bandwidth in Embodiment 1 of a symmetrically fed waveguide antenna array element according to the present disclosure. FIGS. 4A and 4B show a schematic simulation diagram of a radiation pattern in Embodiment 1 of a symmetrically fed waveguide antenna array element according to the present disclosure. As can be seen from FIG. 3 and FIGS. 4A-4B, the symmetrically fed waveguide antenna array element in Embodiment 1 of the present disclosure exhibits desirable performance in the 74-81 GHz band, the antenna exhibits excellent radiation pattern consistency in the 76-79 GHz band, the beam pointing angles in the elevation plane are 0°, and the SLLs are less than -20 dB.

### Embodiment 2

As shown in FIG. 5, a symmetrically fed waveguide antenna array element includes 180° E-plane power divider 1, first E-plane feed line 2, second E-plane feed line 3, first E-plane-to-H-plane waveguide converter 4, second E-plane-to-H-plane waveguide converter 5, H-plane waveguide 6, and radiation slot array 7. A first output port of the 180° E-plane power divider 1 is connected to one end of the first E-plane feed line 2. Another end of the first E-plane feed line 2 is connected to an input end of the first E-plane-to-H-plane waveguide converter 4. An output end of the first E-plane-to-H-plane waveguide converter 4 is connected to one end of the H-plane waveguide 6. A second output port of the 180° E-plane power divider 1 is connected to one end of the second E-plane feed line 3. Another end of the second E-plane feed line 3 is connected to an input end of the second E-plane-to-H-plane waveguide converter 5. An output end of the second E-plane-to-H-plane waveguide converter 5 is connected to another end of the H-plane waveguide 6. The radiation slot array 7 is disposed on a top side of the H-plane waveguide 6. The first E-plane feed line 2 and the second E-plane feed line 3 have a length difference of X, such that a phase difference between signals respectively passing through the two feed lines is 180°. The radiation slot array 7 includes an odd number of radiating apertures.

In the present disclosure, a signal is fed from an input end of the 180° E-plane power divider 1. Through the 180° E-plane power divider 1, energy is equally divided into two paths of signals with a phase difference of 180°. The two paths of signals respectively pass through the first E-plane feed line 2 and the second E-plane feed line 3 having the length difference of X. The two paths of signals have a same phase when respectively reaching the first E-plane-to-H-plane waveguide converter 4 and the second E-plane-to-H-plane waveguide converter 5, and are symmetrically fed into the H-plane waveguide 6.

There are three radiating apertures that are fifth radiating aperture 16, sixth radiating aperture 17, and seventh radiating aperture 18 in sequence. The fifth radiating aperture 16, the sixth radiating aperture 17, and the seventh radiating aperture 18 are rectangular-slot radiating apertures.

The H-plane waveguide 6 includes third rectangular portion 19, third trapezoidal protrusive portion 20, and fourth rectangular portion 21. One end of the third rectangular portion 19 is connected to one end of the third trapezoidal protrusive portion 20. Another end of the third trapezoidal protrusive portion 20 is connected to one end of the fourth rectangular portion 21. The third trapezoidal protrusive portion 20 protrudes toward one side of the H-plane waveguide 6. The third rectangular portion 19 and the fourth rectangular portion 21 are symmetrically disposed on two ends of the third trapezoidal protrusive portion 20.

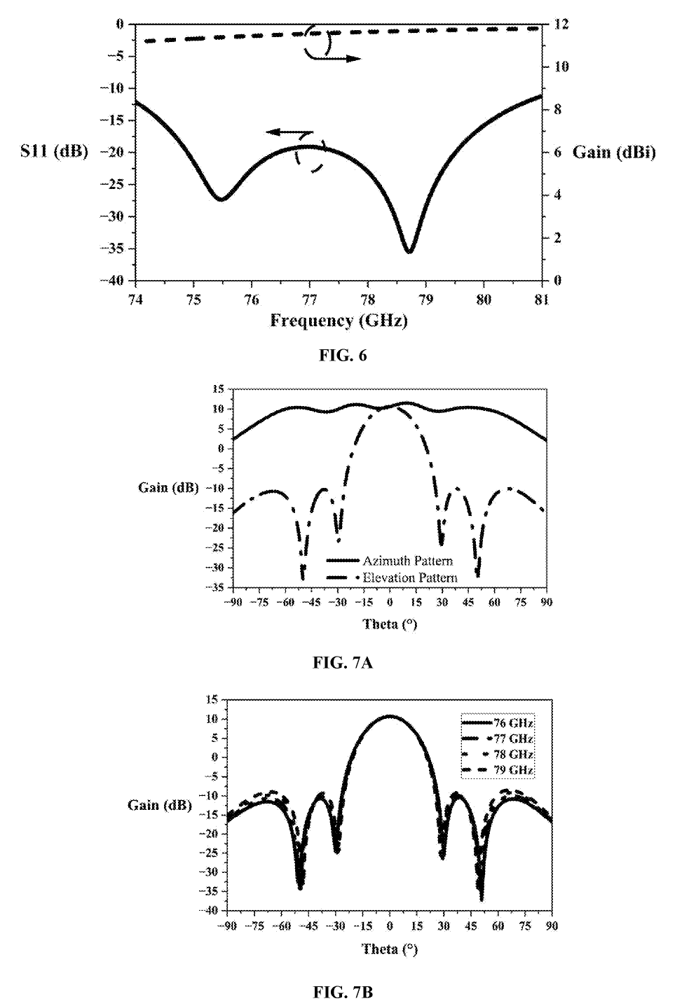

FIG. 6 is a schematic simulation diagram of an operation bandwidth in Embodiment 2 of a symmetrically fed waveguide antenna array element according to the present disclosure. FIGS. 7A and 7B show a schematic simulation diagram of a radiation pattern in Embodiment 2 of a symmetrically fed waveguide antenna array element according to the present disclosure. As can be seen from FIG. 6 and FIGS. 7A-7B, the symmetrically fed waveguide antenna array element in Embodiment 2 of the present disclosure exhibits desirable performance in the 74-81 GHz band, the antenna exhibits excellent radiation pattern consistency in the 76-79 GHz band, the beam pointing angles in the elevation plane are 0°, and the SLLs are less than -20 dB.

### Embodiment 3

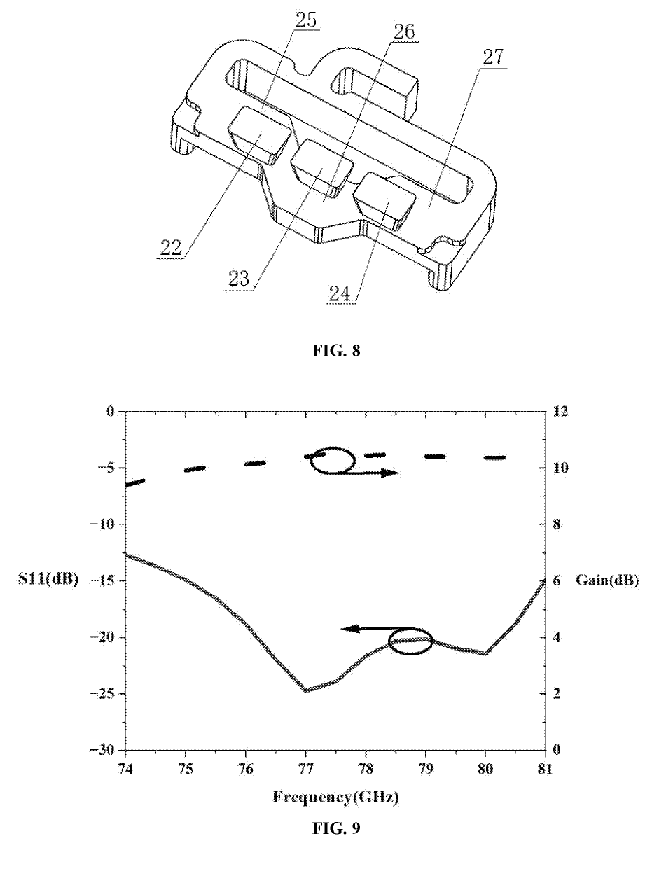

As shown in FIG. 8, a symmetrically fed waveguide antenna array element includes 180° E-plane power divider 1, first E-plane feed line 2, second E-plane feed line 3, first E-plane-to-H-plane waveguide converter 4, second E-plane-to-H-plane waveguide converter 5, H-plane waveguide 6, and radiation slot array 7. A first output port of the 180° E-plane power divider 1 is connected to one end of the first E-plane feed line 2. Another end of the first E-plane feed line 2 is connected to an input end of the first E-plane-to-H-plane waveguide converter 4. An output end of the first E-plane-to-H-plane waveguide converter 4 is connected to one end of the H-plane waveguide 6. A second output port of the 180° E-plane power divider 1 is connected to one end of the second E-plane feed line 3. Another end of the second E-plane feed line 3 is connected to an input end of the second E-plane-to-H-plane waveguide converter 5. An output end of the second E-plane-to-H-plane waveguide converter 5 is connected to another end of the H-plane waveguide 6. The radiation slot array 7 is disposed on a top side of the H-plane waveguide 6. The first E-plane feed line 2 and the second E-plane feed line 3 have a length difference of X, such that a phase difference between signals respectively passing through the two feed lines is 180°. The radiation slot array 7 includes an odd number of radiating apertures.

In the present disclosure, a signal is fed from an input end of the 180° E-plane power divider 1. Through the 180° E-plane power divider 1, energy is equally divided into two paths of signals with a phase difference of 180°. The two paths of signals respectively pass through the first E-plane feed line 2 and the second E-plane feed line 3 having the length difference of X. The two paths of signals have a same phase when respectively reaching the first E-plane-to-H-plane waveguide converter 4 and the second E-plane-to-H-plane waveguide converter 5, and are symmetrically fed into the H-plane waveguide 6.

There are three radiating apertures that are fifth radiating aperture 22, sixth radiating aperture 23, and seventh radiating aperture 24 in sequence. The fifth radiating aperture 22, the sixth radiating aperture 23, and the seventh radiating aperture 24 are rectangular-horn radiating apertures.

The H-plane waveguide 6 includes fifth rectangular portion 25, fourth trapezoidal protrusive portion 26, and sixth rectangular portion 27. One end of the fifth rectangular portion 25 is connected to one end of the fourth trapezoidal protrusive portion 26. Another end of the fourth trapezoidal protrusive portion 26 is connected to one end of the sixth rectangular portion 27. The fourth trapezoidal protrusive portion 26 protrudes toward one side of the H-plane waveguide 6. The fifth rectangular portion 25 and the sixth rectangular portion 27 are symmetrically disposed on two ends of the fourth trapezoidal protrusive portion 26.

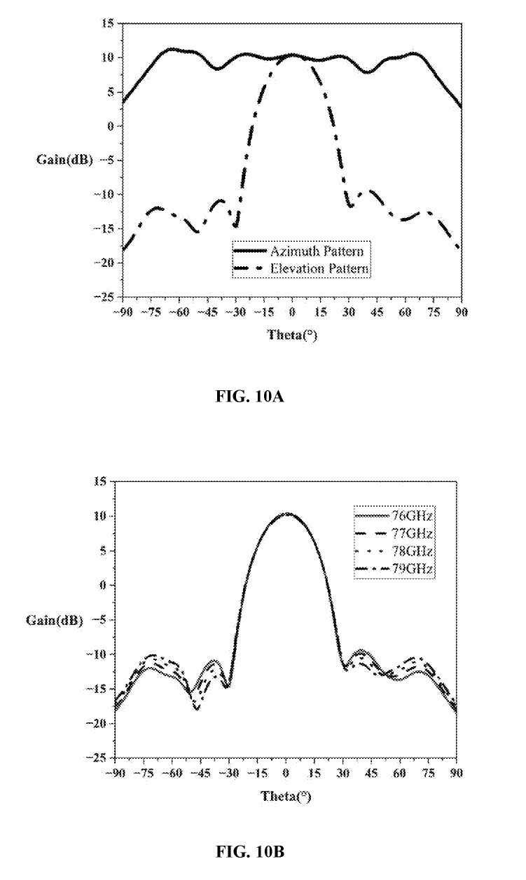

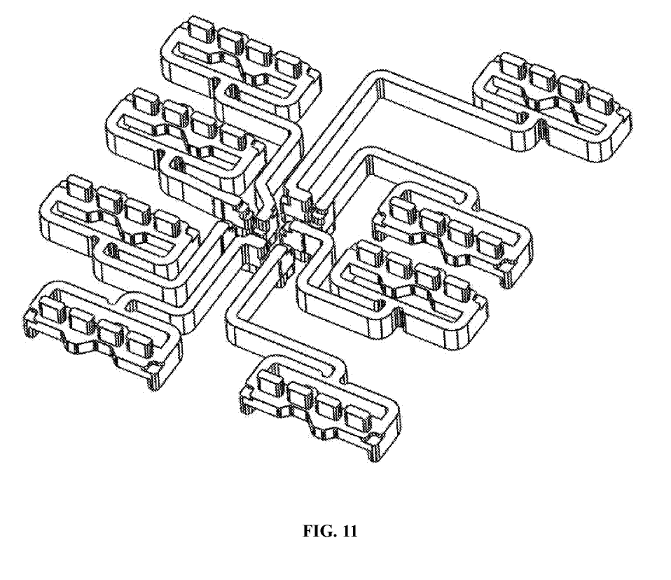

FIG. 9 is a schematic simulation diagram of an operation bandwidth in Embodiment 3 of a symmetrically fed waveguide antenna array element according to the present disclosure. FIGS. 10A-10B show a schematic simulation diagram of a radiation pattern in Embodiment 3 of a symmetrically fed waveguide antenna array element according to the present disclosure. As can be seen from FIG. 9 and FIGS. 10A-10B, the symmetrically fed waveguide antenna array element in Embodiment 3 of the present disclosure exhibits desirable performance in the 74-81 GHz band, the antenna exhibits excellent radiation pattern consistency in the 76-79 GHz band, the beam pointing angles in the elevation plane are 0°, and the SLLs are less than -20 dB.

### Embodiment 4

As shown in FIG. 11, a waveguide antenna array includes an even number of symmetrically fed waveguide antenna array elements. The even number of symmetrically fed waveguide antenna array elements are equally divided into two groups. One group of symmetrically fed waveguide antenna array elements serves as a signal transmitting element group, while the other group of symmetrically fed waveguide antenna array elements serves as a signal receiving element group. An input end of 180° E-plane power divider 1 of each symmetrically fed waveguide antenna array element is connected to a waveguide converter on a chip port through an E-plane waveguide feed line. A signal is transmitted to the E-plane waveguide feed line through the waveguide converter on the chip port, and fed into the symmetrically fed waveguide antenna array element through the 180° E-plane power divider 1. A four-transmitter four-receiver (4T4R) model is used in the embodiment. With the compact symmetric feeding scheme, the overall size of the antenna is not increased compared with the traditional center feeding or side feeding scheme. Due to differential feeding, partial interference during transmission can be counteracted, which can improve the consistency of the antenna between the elements. As shown in the figure, the differential symmetric feeding scheme improves the consistency by approximately 2 dB compared with the common scheme.

The present disclosure makes use of the symmetric feeding scheme to expand the operation bandwidth of the antenna. High symmetry of the feeding can ensure the symmetry of the radiation pattern. With the differential symmetric feeding scheme, the present disclosure transmits the signal in positive and negative paths, and this process is called differential transmission. The two paths of signals can mutually counteract partial interference during transmission due to their different polarities, thereby achieving more stable signal transmission, and ensuring that SLLs at all angles are not aggravated by such interference. Since the symmetric feeding networks are compact, and are located at a same side of the waveguide antenna, the present disclosure only requires two layers of waveguides, reducing the cost, and omitting the mounting of one layer. With the differential symmetric feeding scheme, the present disclosure transmits the signal in positive and negative paths, and this process is called differential transmission. The two paths of signals can mutually counteract partial interference during transmission due to their different polarities, thereby achieving more stable signal transmission, and ensuring that SLLs at all angles are not aggravated by such interference. The present disclosure is applicable to the even number of radiating apertures or the odd number of radiating apertures. It can be implemented either on a metallized injection-molded part and a thin copper sheet, or on two metallized injection-molded parts.

With the differential symmetric feeding scheme and the equally-divided symmetric feeding scheme, the present disclosure has advantages of a broad operation bandwidth, a symmetric radiation pattern, and flexible adjustment for the physical aperture size of the antenna, and can address many key pain points. By optimizing the impedance matching, the present disclosure makes symmetric feeding networks more compact to achieve wide application scenarios. The present disclosure can be implemented either on two metallized injection-molded parts via welding, or on a metallized injection-molded part and a thin copper sheet, thereby significantly reducing the thickness of the antenna. The H-plane waveguide can be not only a cavity waveguide but also a ridge waveguide.

The above are only preferred embodiments of the present disclosure, and are not intended to limit the present disclosure in any form. Although the present disclosure has been disclosed by the foregoing embodiments, these embodiments are not intended to limit the present disclosure. Any person skilled in the art may make some changes or modifications to implement equivalent embodiments with equivalent changes by using the technical contents disclosed above without departing from the scope of the technical solution of the present disclosure. Any simple modification, equivalent change and modification made to the foregoing embodiments according to the technical essence of the present disclosure without departing from the content of the technical solution of the present disclosure shall fall within the scope of the technical solution of the present disclosure.

1. A symmetrically fed waveguide antenna array element, comprising: a 180° E-plane power divider, a first E-plane feed line, a second E-plane feed line, a first E-plane-to-H-plane waveguide converter, a second E-plane-to-H-plane waveguide converter, an H-plane waveguide, and a radiation slot array, wherein a first output port of the 180° E-plane power divider is connected to one end of the first E-plane feed line; another end of the first E-plane feed line is connected to an input end of the first E-plane-to-H-plane waveguide converter; an output end of the first E-plane-to-H-plane waveguide converter is connected to one end of the H-plane waveguide; a second output port of the 180° E-plane power divider is connected to one end of the second E-plane feed line; another end of the second E-plane feed line is connected to an input end of the second E-plane-to-H-plane waveguide converter; an output end of the second E-plane-to-H-plane waveguide converter is connected to another end of the H-plane waveguide; the radiation slot array is disposed on a top side of the H-plane waveguide; a length of the first E-plane feed line and a length of the second E-plane feed line are equal; and the radiation slot array comprises an even number of radiating apertures.

2. The symmetrically fed waveguide antenna array element according to claim 1, wherein the first E-plane-to-H-plane waveguide converter and the second E-plane-to-H-plane waveguide converter each are provided with an impedance matching step.

3. The symmetrically fed waveguide antenna array element according to claim 1, wherein there are four radiating apertures, including a first radiating aperture, a second radiating aperture, a third radiating aperture, and a fourth radiating aperture in sequence; the first radiating aperture, the second radiating aperture, the third radiating aperture, and the fourth radiating aperture have dimensions of 0.9 mm × 2.2 mm × 1.7 mm; and a center-to-center spacing between adjacent ones of the first radiating aperture, the second radiating aperture, the third radiating aperture, and the fourth radiating aperture is 3.3 mm.

4. The symmetrically fed waveguide antenna array element according to claim 3, wherein the H-plane waveguide comprises a first rectangular portion, a first trapezoidal protrusive portion, a second trapezoidal protrusive portion, and a second rectangular portion; one end of the first rectangular portion is connected to one end of the first trapezoidal protrusive portion; another end of the first trapezoidal protrusive portion is connected to one end of the second trapezoidal protrusive portion; another end of the second trapezoidal protrusive portion is connected to one end of the second rectangular portion; the first trapezoidal protrusive portion protrudes toward one side of the H-plane waveguide; the second trapezoidal protrusive portion protrudes toward another side of the H-plane waveguide; the first trapezoidal protrusive portion and the second trapezoidal protrusive portion are point-symmetric about a central point of the H-plane waveguide; the first rectangular portion and the second rectangular portion are offset toward two sides of the H-plane waveguide in a length direction; and the first rectangular portion and the second rectangular portion are point-symmetric about the central point of the H-plane waveguide.

5. A symmetrically fed waveguide antenna array element, comprising: a 180° E-plane power divider, a first E-plane feed line, a second E-plane feed line, a first E-plane-to-H-plane waveguide converter, a second E-plane-to-H-plane waveguide converter, an H-plane waveguide, and a radiation slot array, wherein a first output port of the 180° E-plane power divider is connected to one end of the first E-plane feed line; another end of the first E-plane feed line is connected to an input end of the first E-plane-to-H-plane waveguide converter; an output end of the first E-plane-to-H-plane waveguide converter is connected to one end of the H-plane waveguide; a second output port of the 180° E-plane power divider is connected to one end of the second E-plane feed line; another end of the second E-plane feed line is connected to an input end of the second E-plane-to-H-plane waveguide converter; an output end of the second E-plane-to-H-plane waveguide converter is connected to another end of the H-plane waveguide; the radiation slot array is disposed on a top side of the H-plane waveguide; the first E-plane feed line and the second E-plane feed line have a length difference of X, and a phase difference between signals respectively passing through the two feed lines is 180°; and the radiation slot array comprises an odd number of radiating apertures.

6. The symmetrically fed waveguide antenna array element according to claim 5, wherein there are three radiating apertures, including a fifth radiating aperture, a sixth radiating aperture, and a seventh radiating aperture in sequence.

7. The symmetrically fed waveguide antenna array element according to claim 6, wherein the H-plane waveguide comprises a third rectangular portion, a third trapezoidal protrusive portion, and a fourth rectangular portion; one end of the third rectangular portion is connected to one end of the third trapezoidal protrusive portion; another end of the third trapezoidal protrusive portion is connected to one end of the fourth rectangular portion; the third trapezoidal protrusive portion protrudes toward one side of the H-plane waveguide; and the third rectangular portion and the fourth rectangular portion are symmetrically disposed on two ends of the third trapezoidal protrusive portion.

8. The symmetrically fed waveguide antenna array element according to claim 6, wherein the fifth radiating aperture, the sixth radiating aperture, and the seventh radiating aperture are rectangular-slot radiating apertures.

9. The symmetrically fed waveguide antenna array element according to claim 6, wherein the fifth radiating aperture, the sixth radiating aperture, and the seventh radiating aperture are rectangular-horn radiating apertures.

10. A waveguide antenna array, comprising: an even number of symmetrically fed waveguide antenna array elements according to claim 1, wherein the even number of symmetrically fed waveguide antenna array elements are equally divided into two groups; and one group of symmetrically fed waveguide antenna array elements serves as a signal transmitting element group, while the other group of symmetrically fed waveguide antenna array elements serves as a signal receiving element group.

11. The waveguide antenna array according to claim 10, wherein the first E-plane-to-H-plane waveguide converter and the second E-plane-to-H-plane waveguide converter each are provided with an impedance matching step.

12. The waveguide antenna array according to claim 10, wherein there are four radiating apertures, including a first radiating aperture, a second radiating aperture, a third radiating aperture, and a fourth radiating aperture in sequence; the first radiating aperture, the second radiating aperture, the third radiating aperture, and the fourth radiating aperture have dimensions of 0.9 mm × 2.2 mm × 1.7 mm; and a center-to-center spacing between adjacent ones of the first radiating aperture, the second radiating aperture, the third radiating aperture, and the fourth radiating aperture is 3.3 mm.

13. The waveguide antenna array according to claim 12, wherein the H-plane waveguide comprises a first rectangular portion, a first trapezoidal protrusive portion, a second trapezoidal protrusive portion, and a second rectangular portion; one end of the first rectangular portion is connected to one end of the first trapezoidal protrusive portion; another end of the first trapezoidal protrusive portion is connected to one end of the second trapezoidal protrusive portion; another end of the second trapezoidal protrusive portion is connected to one end of the second rectangular portion; the first trapezoidal protrusive portion protrudes toward one side of the H-plane waveguide; the second trapezoidal protrusive portion protrudes toward another side of the H-plane waveguide; the first trapezoidal protrusive portion and the second trapezoidal protrusive portion are point-symmetric about a central point of the H-plane waveguide; the first rectangular portion and the second rectangular portion are offset toward two sides of the H-plane waveguide in a length direction; and the first rectangular portion and the second rectangular portion are point-symmetric about the central point of the H-plane waveguide.

14. A waveguide antenna array, comprising: an even number of symmetrically fed waveguide antenna array elements according to claim 5, wherein the even number of symmetrically fed waveguide antenna array elements are equally divided into two groups; and one group of symmetrically fed waveguide antenna array elements serves as a signal transmitting element group, while the other group of symmetrically fed waveguide antenna array elements serves as a signal receiving element group.

15. The waveguide antenna array according to claim 14, wherein there are three radiating apertures, including a fifth radiating aperture, a sixth radiating aperture, and a seventh radiating aperture in sequence.

16. The waveguide antenna array according to claim 15, wherein the H-plane waveguide comprises a third rectangular portion, a third trapezoidal protrusive portion, and a fourth rectangular portion; one end of the third rectangular portion is connected to one end of the third trapezoidal protrusive portion; another end of the third trapezoidal protrusive portion is connected to one end of the fourth rectangular portion; the third trapezoidal protrusive portion protrudes toward one side of the H-plane waveguide; and the third rectangular portion and the fourth rectangular portion are symmetrically disposed on two ends of the third trapezoidal protrusive portion.

17. The waveguide antenna array according to claim 15, wherein the fifth radiating aperture, the sixth radiating aperture, and the seventh radiating aperture are rectangular-slot radiating apertures.

18. The waveguide antenna array according to claim 15, wherein the fifth radiating aperture, the sixth radiating aperture, and the seventh radiating aperture are rectangular-horn radiating apertures.
